(19) United States
(12) Patent Application Publication
(10) Pub. No.: US 2025/0259810 A1
(43) Pub. Date: Aug. 14, 2025

(54) MODULAR SWITCHGEAR

(71) Applicant: G & W ELECTRIC COMPANY, Bolingbrook, IL (US)

(72) Inventors: Arturas Dauksas, Oak Lawn, IL (US); Vincent Marec, Bolingbrook, IL (US); Janet Ache, Bolingbrook, IL (US); Blair S. Kerr, Downers Grove, IL (US)

(21) Appl. No.: 19/096,289

(22) Filed: Mar. 31, 2025

Related U.S. Application Data
(62) Division of application No. 17/606,373, filed on Oct. 25, 2021, now Pat. No. 12,266,490.
(60) Provisional application No. 62/839,278, filed on Apr. 26, 2019.
(60) Provisional application No. 62/882,060, filed on Aug. 2, 2019.

(51) Int. Cl. H01H 33/662; H01H 33/666; H01H 50/02; H01H 50/16

(52) U.S. Cl. CPC H01H 33/66207; H01H 33/6662; H01H 50/02; H01H 50/16

(57) ABSTRACT

A switchgear apparatus includes a vacuum interrupter assembly having a movable contact and a stationary contact, a main housing surrounding the vacuum interrupter assembly, and a first terminal electrically coupled to one of the movable contact and the stationary contact, the first terminal extending from the main housing along a first axis. The switchgear apparatus also includes a second terminal electrically coupled to the other of the movable contact and the stationary contact, the second terminal extending from the main housing along a second axis, and a mounting head couplable to the main housing in a plurality of orientations about the first axis.

### CROSS-REFERENCE TO RELATED APPLICATIONS

This patent application is a division of U.S. patent application Ser. No. 17/606,373, filed Apr. 24, 2020, which is a national phase entry pursuant to 35 U.S.C. § 371 of International Patent Application No. PCT/US2020/029865, filed on Apr. 24, 2020, which claims priority to U.S. Provisional Patent Application No. 62/839,278 filed on Apr. 26, 2019, and to U.S. Provisional Patent Application No. 62/882,060 filed on Aug. 2, 2019, the entire contents of all of which are incorporated herein by reference.

### FIELD OF THE DISCLOSURE

The present disclosure relates to solid dielectric switchgear, and more particularly to reclosers.

### BACKGROUND OF THE DISCLOSURE

Reclosers are switchgear that provide line protection, for example, on overhead electrical power lines and/or substations and serve to segment the circuits into smaller sections, reducing the number of potentially impacted customers in the event of a short circuit. Previously, reclosers were controlled using hydraulics. More recently, solid dielectric reclosers have been developed for use at voltages up to 38 kV. Solid dielectric reclosers may be paired with electronic control devices to provide automation and “smart” recloser functionality.

### SUMMARY OF THE DISCLOSURE

A need exists for fault protection and circuit segmentation in power transmission circuits, which typically operate at higher voltages (e.g., up to 1,100 kV). Reclosers allow for multiple automated attempts to clear temporary faults on overhead lines. In power transmission systems, this function is typically achieved using circuit breakers in substations. The present disclosure provides a modular recloser that can operate at voltages up to 72.5 kV and that can be pole-mounted outside of a substation. By enabling the placement of reclosers outside the substation, the present disclosure advantageously enables over-current protection to be positioned closer to potential faults and thereby segment the portion of the power transmission circuit affected by the fault to a smaller section. This reduces the potential impact of a fault to a smaller number of customers or end users, improving the power transmission system's reliability.

The present disclosure provides, in one aspect, a switchgear apparatus including a vacuum interrupter assembly having a movable contact and a stationary contact, a main housing surrounding the vacuum interrupter assembly, and a first terminal electrically coupled to one of the movable contact and the stationary contact, the first terminal extending from the main housing along a first axis. The switchgear apparatus also includes a second terminal electrically coupled to the other of the movable contact and the stationary contact, the second terminal extending from the main housing along a second axis, and a mounting head couplable to the main housing in a plurality of orientations about the first axis.

The present disclosure provides, in another aspect, a switchgear apparatus and mounting bracket assembly that includes a switchgear apparatus. The switchgear apparatus includes a vacuum interrupter assembly having a movable contact and a stationary contact, a main housing surrounding the vacuum interrupter assembly, a first terminal electrically coupled to one of the movable contact and the stationary contact, the first terminal extending from the main housing along a first axis, a second terminal electrically coupled to the other of the movable contact and the stationary contact, the second terminal extending from the main housing along a second axis, and a mounting head selectively couplable to the main housing in a plurality of orientations. The switchgear apparatus and mounting bracket assembly also includes a mounting bracket coupled to the mounting head.

The present disclosure provides, in another aspect, a switchgear apparatus and mounting bracket assembly including a mounting bracket and a switchgear apparatus. The switchgear apparatus includes a vacuum interrupter assembly having a movable contact and a stationary contact, a main housing surrounding the vacuum interrupter assembly, a first terminal electrically coupled to one of the movable contact and the stationary contact, the first terminal extending from the main housing along a first axis, a second terminal electrically coupled to the other of the movable contact and the stationary contact, the second terminal extending from the main housing along a second axis, and a mounting head configured to be coupled to the mounting bracket such that the mounting bracket is configured to at least partially support the switchgear apparatus via the mounting head. The switchgear apparatus is configurable to position at least one of the first axis or the second axis in a plurality of different orientations with respect to the mounting bracket when the mounting head is coupled to the mounting bracket.

Other aspects of the invention will become apparent by consideration of the detailed description and accompanying drawings.

### BRIEF DESCRIPTION OF THE DRAWINGS

FIG. 1 is a perspective view of a recloser according to an embodiment of the present disclosure.

FIG. 2 is a cross-sectional view of the recloser of FIG. 1.

FIG. 3 is an exploded perspective view of a housing of the recloser of FIG. 1.

FIG. 4 is a perspective view of a mount of the recloser of FIG. 1.

FIG. 5 is a cross-sectional view of the recloser of FIG. 1, illustrating the mount of FIG. 4.

FIG. 6 is a perspective view of an assembly including the recloser of FIG. 1 coupled to a bracket in a first vertical orientation.

FIG. 7A is a top view of the assembly of FIG. 6.

FIG. 7B is a top view of the assembly of FIG. 6 illustrating the recloser in a second vertical orientation.

FIG. 7C is a top view of the assembly of FIG. 6 illustrating the recloser in a third vertical orientation.

FIG. 7D is a top view of the assembly of FIG. 6 illustrating the recloser in a fourth vertical orientation.

FIG. 7E is a top view of the assembly of FIG. 6 illustrating the recloser in a fifth vertical orientation.

FIG. 7F is a top view of the assembly of FIG. 6 illustrating the recloser in a sixth vertical orientation.

FIG. 8 is a front view of the assembly of FIG. 6 illustrating the recloser in a first horizontal orientation.

FIG. 9A is a right side view of the assembly of FIG. 8.

FIG. 9B is a right side view of the assembly of FIG. 6 illustrating the recloser in a second horizontal orientation.

FIG. 9C is a right side view of the assembly of FIG. 6 illustrating the recloser in a third horizontal orientation.

FIG. 10 is a front view of the assembly of FIG. 6 illustrating the recloser in a fourth horizontal orientation.

FIG. 11A is a left side view of the assembly of FIG. 10.

FIG. 11B is a left side view of the assembly of FIG. 6 illustrating the recloser in a fifth horizontal orientation.

FIG. 11C is a left side view of the assembly of FIG. 6 illustrating the recloser in a sixth horizontal orientation.

FIG. 12 illustrates a plurality of the assemblies of FIG. 6 mounted to a pole, with each recloser in the first vertical orientation.

FIG. 13 illustrates a plurality of the assemblies of FIG. 8 mounted to a pole, with each recloser in the first horizontal orientation.

FIG. 14 is a side view of an assembly according to another embodiment, the assembly including a bracket and a recloser coupled to the bracket in an angled orientation.

### DETAILED DESCRIPTION

Before any embodiments are explained in detail, it is to be understood that the arrangements are not limited in application to the details of construction and arrangement of components set forth in the following description or illustrated in the following drawings. The invention is capable of other embodiments and of being practiced or of being carried out in various ways.

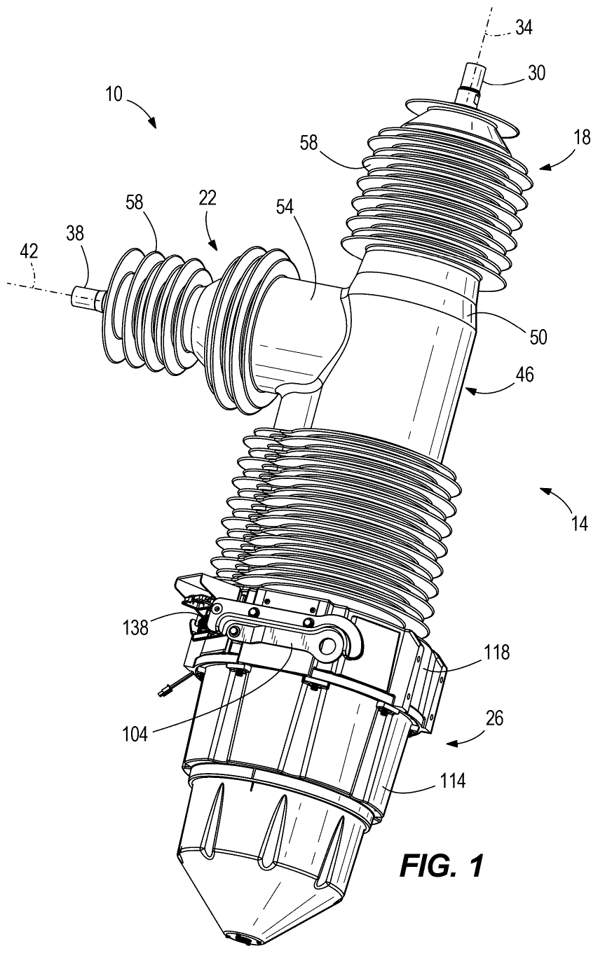

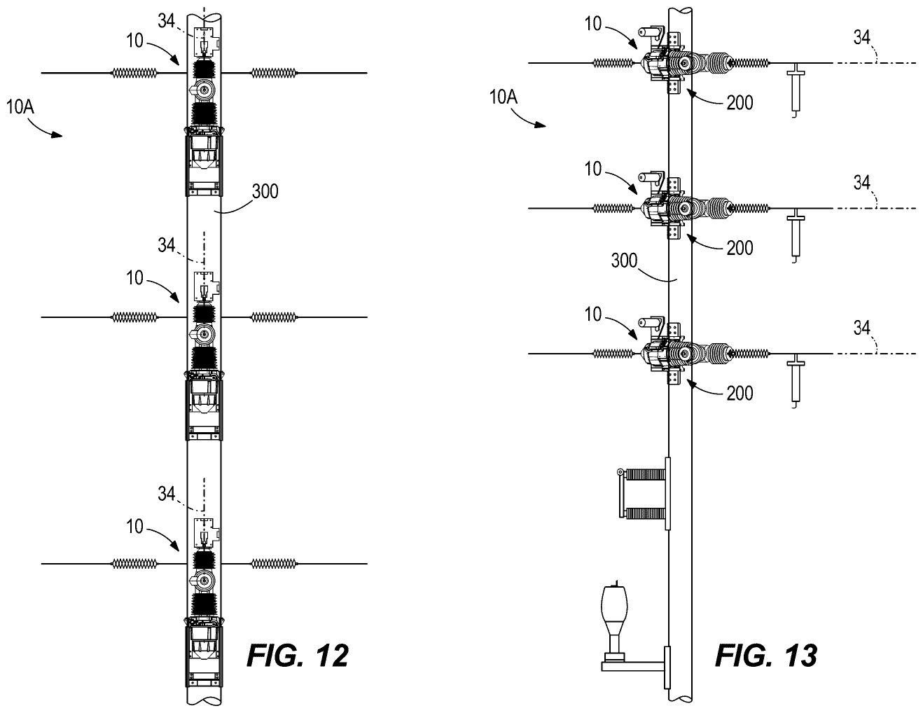

FIG. 1 illustrates a recloser 10 according to an embodiment of the present disclosure. The recloser 10 includes a housing assembly 14, a vacuum interrupter (“VI”) assembly 18, a conductor assembly 22, which in some embodiments may be a load-side conductor assembly 22 and in other embodiments may be a source-side conductor assembly 22, and an actuator assembly 26. The VI assembly 18 includes a first terminal 30 extending from the housing assembly 14 along a first longitudinal axis 34, and the conductor assembly 22 includes a second terminal 38 extending from the housing assembly 14 along a second longitudinal axis 42 perpendicular to the first longitudinal axis 34. In other embodiments, the second longitudinal axis 42 may be obliquely oriented relative to the first longitudinal axis 34. As described in greater detail below, the actuator assembly 26 operates the VI assembly 18 to selectively break and/or reestablish a conductive pathway between the first and second terminals 30, 38. Although the recloser 10 is illustrated individually in FIG. 1, the recloser 10 may be part of a recloser system 10A (e.g., FIGS. 12-13) including a plurality of reclosers 10, each associated with a different phase of a three-phase power transmission system and ganged together such that operation of the plurality of reclosers 10 is synchronized. In some embodiments, the reclosers 10 of the recloser system 10A may be operable individually (i.e. the reclosers 10 may open and/or close independently from one another).

The illustrated housing assembly 14 includes a main housing 46 constructed from an insulating material, such as epoxy, that forms a solid dielectric module. For example, the main housing 46 can be constructed from a silicone or cycloaliphatic epoxy or a fiberglass molding compound. In the illustrated embodiment, the main housing 46 is covered with a silicone rubber layer that withstands heavily polluted environments and serves as a dielectric material for the recloser 10. The silicone rubber layer may be overmolded onto the main housing 46. In the illustrated embodiment, the main housing 46 includes a first bushing 50 that surrounds and at least partially encapsulates the VI assembly 18, and a second bushing 54 that surrounds and at least partially encapsulates the conductor assembly 22. The silicone rubber layer includes a plurality of sheds 58 extending radially outward from both bushings 50, 54. The first and second bushings 50, 54 are integrally formed together with the main housing 46 as a single monolithic structure in the illustrated embodiment. Alternatively, the first and second bushings 50, 54 may be formed separately and coupled to the main housing 46 in a variety of ways (e.g., via a threaded connection, snap-fit, etc.).

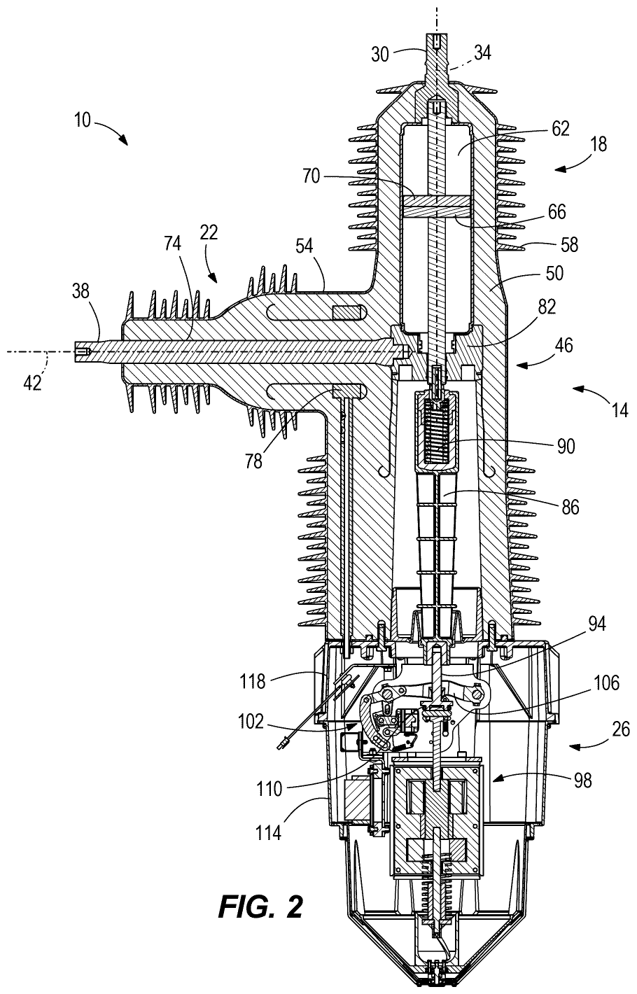

With reference to FIG. 2, the VI assembly 18 includes a vacuum bottle 62 at least partially molded within the first bushing 50 of the main housing 46. The vacuum bottle 62 encloses a movable contact 66 and a stationary contact 70 such that the movable contact 66 and the stationary contact 70 are hermetically sealed within the vacuum bottle 62. In some embodiments, the vacuum bottle 62 has an internal absolute pressure of about 1 millipascal or less. The movable contact 66 is movable along the first longitudinal axis 34 between a closed position (illustrated in FIG. 2) and an open position (not shown) to selectively establish or break contact with the stationary contact 70. The vacuum bottle 62 quickly suppresses electrical arcing that may occur when the contacts 66, 70 are opened due to the lack of conductive atmosphere within the bottle 62.

The conductor assembly 22 includes a conductor 74 and a sensor assembly 78, each at least partially molded within the second bushing 54 of the main housing 46. The sensor assembly 78 can include a current sensor, voltage sensor, partial discharge sensor, voltage indicated sensor, and/or other sensing devices. One end of the conductor 74 is electrically coupled to the movable contact 66 via a current interchange 82. The opposite end of the conductor 74 is electrically coupled to the second terminal 38. The first terminal 30 is electrically coupled to the stationary contact 70. The first terminal 30 and the second terminal 38 are configured for connection to respective electrical power transmission lines.

With continued reference to FIG. 2, the actuator assembly 26 includes a drive shaft 86 extending through the main housing 46 and coupled at one end to the movable contact 66 of the VI assembly 18. In the illustrated embodiment, the drive shaft 86 is coupled to the movable contact 66 via an encapsulated spring 90 to permit limited relative movement between the drive shaft 86 and the movable contact 66. The encapsulated spring 90 biases the movable contact 66 toward the stationary contact 70. The opposite end of the drive shaft 86 is coupled to an output shaft 94 of an electromagnetic actuator 98. The electromagnetic actuator 98 is operable to move the drive shaft 86 along the first longitudinal axis 34 and thereby move the movable contact 66 relative to the stationary contact 70. In additional or alternative embodiments, the functionality provided by the encapsulated spring 90 may be provided with an external spring and/or a spring positioned otherwise along the drive shaft 86. For example, the spring may be instead positioned at a first end or at a second end of the drive shaft 86.

The actuator assembly 26 includes a controller (not shown) that controls operation of the electromagnetic actuator 98. In some embodiments, the controller receives feedback from the sensor assembly 78 and energizes or de-energizes the electromagnetic actuator 98 in response to one or more sensed conditions. For example, the controller may receive feedback from the sensor assembly 78 indicating that a fault has occurred. In response, the controller may control the electromagnetic actuator 98 to automatically open the VI assembly 18 and break the circuit. The controller may also control the electromagnetic actuator 98 to automatically close the VI assembly 18 once the fault has been cleared (e.g., as indicated by the sensor assembly 78).

In the illustrated embodiment, the actuator assembly 26 further includes a manual trip assembly 102 that can be used to manually open the VI assembly 18. The manual trip assembly 102 includes a handle 104 accessible from an exterior of the housing assembly 14 (FIG. 1). The handle 104 is rotatable to move a yoke 106 inside the housing assembly 14 (FIG. 2). The yoke 106 is engageable with a collar 110 on the output shaft 94 to move the movable contact 66 toward the open position.

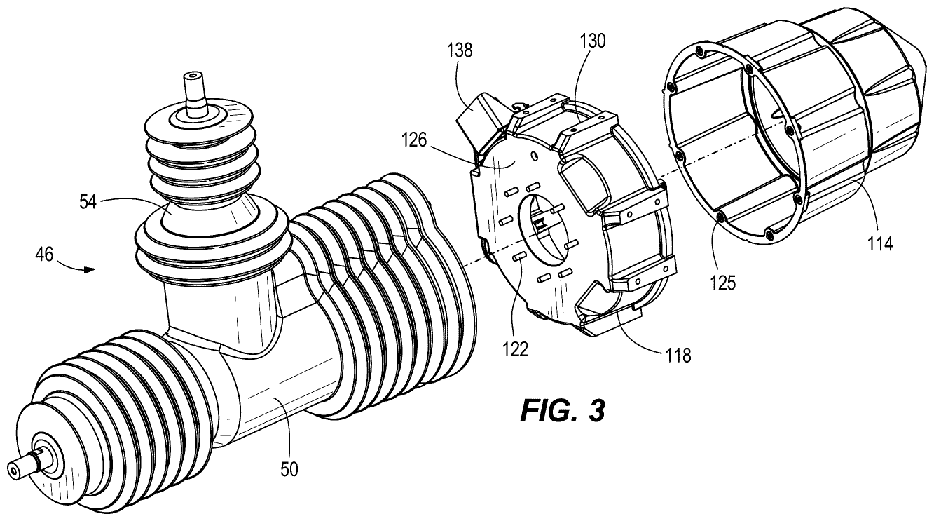

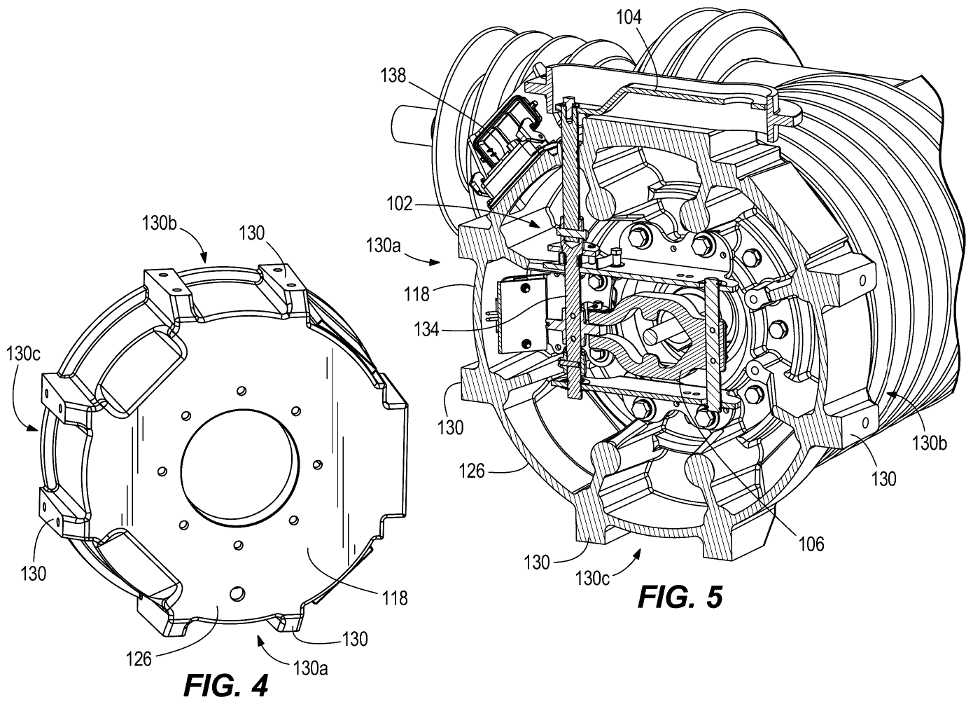

Referring to FIGS. 2 and 3, the housing assembly 14 further includes an actuator housing 114 enclosing the electromagnetic actuator 98 and a mounting head 118 coupled between the actuator housing 114 and the main housing 46. In the illustrated embodiment, the mounting head 118 is coupled to the main housing 46 by a first plurality of threaded fasteners 122, and the actuator housing 114 is coupled to the mounting head 118 opposite the main housing 46 by a second plurality of threaded fasteners 125 (FIG. 3). Referring to FIGS. 4 and 5, the mounting head 118 includes a main body 126 and a plurality of mounting bosses 130 spaced along the outer periphery of the main body 126. In the illustrated embodiment, the plurality of mounting bosses 130 includes a first pair of bosses 130a extending from the main body 126 in a first direction, a second pair of bosses 130b extending from the main body 126 in a second direction opposite the first direction, and a third pair of bosses 130c extending from the main body 126 in a third direction orthogonal to the first and second directions. In other embodiments, the mounting head 118 may include a different number and/or arrangement of mounting bosses 130.

The mounting head 118 is couplable to the main housing 46 in a plurality of different orientations such that the pairs of bosses 130 (130a, 130b, 130c) may be positioned in a number of different rotational orientations about axis 34 with respect to the main housing 46. That is, the rotational orientation of the pairs of bosses 130 about the circumference of the main housing 46 may be varied as desired by rotating the orientation of the mounting head 118 and main housing 46 relative to one another about the axis 34 to a desired position before coupling the mounting head 118 and the main housing 46. In some embodiments, the mounting head 118 may be coupled to the main housing 46 in at least three different orientations. In other embodiments, the mounting head 118 may be coupled to the main housing 46 in at least six different orientations. In other embodiments, the main housing 46, the mounting head 118, and the actuator housing 114 may be coupled together in other ways (e.g., via direct threaded connections or the like).

With reference to FIG. 5, the handle 104 of the manual trip assembly 102 extends along a side of the main body 126 opposite the third pair of bosses 130c. The handle 104 is coupled to the yoke 106 via a shaft 134 extending through the main body 126. In the illustrated embodiment, the main body 126 of the mounting head 118 also supports a connector 138. In the illustrated embodiment, the connector 138 is positioned between the handle 104 and the first pair of bosses 130a along the outer periphery of the main body 126. The connector 138 is in communication with the sensor assembly 78 such that feedback from the sensor assembly 78 may be obtained by interfacing with the connector 138.

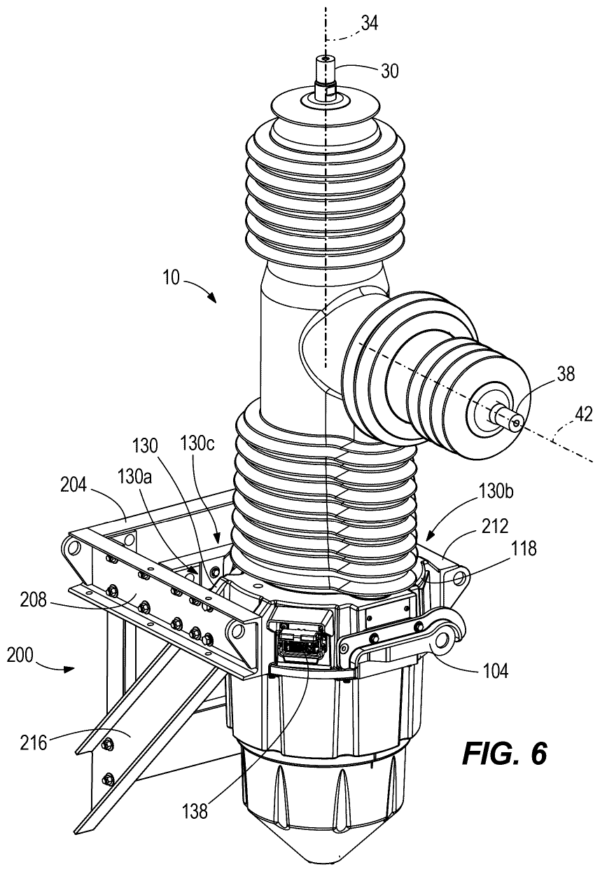

Referring to FIG. 6, the illustrated recloser 10 is provided with a mounting bracket 200 that interfaces with the bosses 130 on the mounting head 118 to facilitate mounting the recloser 10 in a variety of different orientations. The illustrated mounting bracket 200 includes a backing frame 204, a first arm 208 extending perpendicularly from the backing frame 204, a second arm 212 extending perpendicularly from the backing frame 204 and spaced from the first arm 208, a first brace 216 extending at an angle between the backing frame 204 and the first arm 208, and a second brace (not shown) structured and oriented in the same manner as the first brace 216 extending at an angle between the backing frame 204 and the second arm 212. As such, the illustrated mounting bracket 200 is generally U-shaped.

The recloser 10 is received within a space defined between the arms 208, 212 such that the handle 104 and connector 138 face away from the backing frame 204. As such, the handle 104 and connector 138 are easily accessible when the recloser 10 is attached to the mounting bracket 200. The first arm 208 is coupled to the first pair of bosses 130a, and the second arm 212 is coupled to the second pair of bosses 130b (e.g., with a plurality of threaded fasteners; not shown). In some embodiments, the backing frame 204 may be coupled to the third pair of bosses 130c, either directly or intermediate mounting hardware. Thus, the mounting bracket 200 may be attached to the mounting head 118 of the recloser 10 on three different sides to securely hold the recloser 10. In some embodiments, the backing frame 204 may not be coupled to the third pair of bosses 130c, such that the mounting bracket 200 and the mounting head 118 of the recloser 10 may be attached on only two different sides.

With reference to FIGS. 12-13, the recloser 10 may be part of a recloser system 10A including three reclosers 10—each associated with a different phase of a three-phase power transmission system. The mounting bracket 200 advantageously allows each recloser 10 to be mounted to, for example, a pole 300 in a vertical orientation (FIG. 12), in which the first axis 34 is oriented generally parallel to the pole 300 and generally perpendicular to the ground, and in a horizontal orientation for the exemplary vertical pole 300 (FIG. 13), in which the first axis 34 is oriented generally perpendicular to the pole 300 and generally parallel to the ground. Of course, depending on the orientation of the pole 300, the possible varied orientations of a particular recloser 10 relative to the ground would be different from those illustrated in the exemplary embodiments of FIGS. 12 and 13. Each recloser 10 can thus be conveniently used with different wiring configurations, clearances, or spacings when mounted to a pole 300, which facilitates installation of the recloser system 10A outside of substations. The mounting bracket 200 may also be used to mount the recloser 10 in a substation in either a vertical or horizontal orientation.

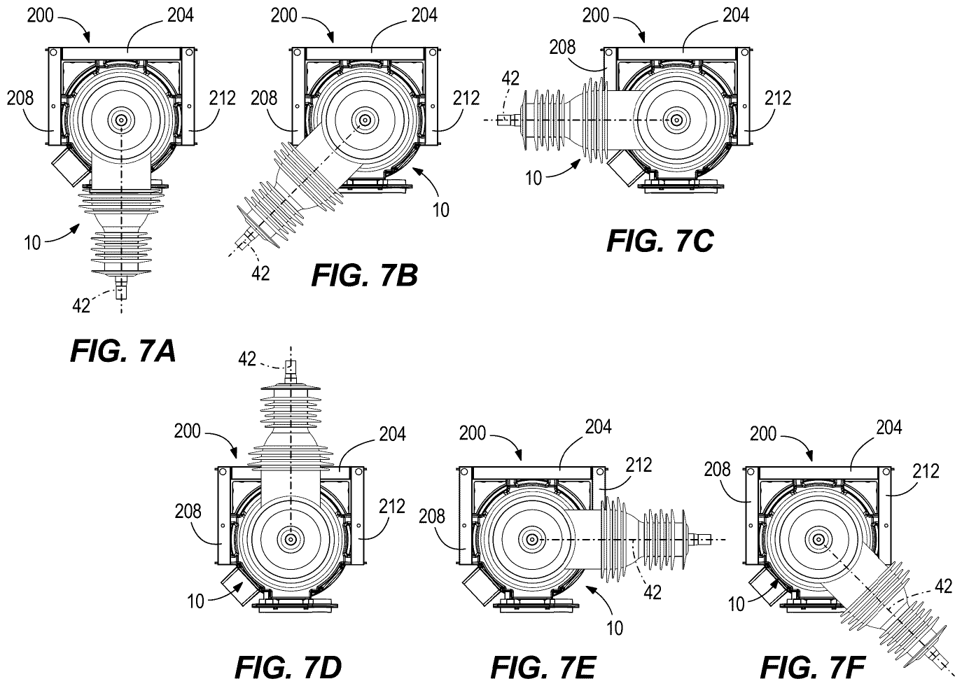

With reference to FIGS. 7A-7F, the exemplary embodiment of the mounting head 118 allows the recloser 10 (specifically, the main housing 46 of the recloser 10 in some embodiments) to be coupled to the bracket 200 in at least six different rotational orientations about the first axis 34 to provide the recloser 10 with an even greater variety of mounting configurations. As explained above, the rotational orientation about first axis 34 in which the mounting head 118 can be coupled to the main housing 46 can be varied. In other embodiments, the rotational orientation of the second axis 42 and the second terminal 38 of the recloser 10 can be varied relative to the mounting bracket 200 by coupling the mounting head 118 to the mounting bracket 200 in different rotational orientations about the first axis 34. Thus, the orientation of the second axis 42 (and thus, the second terminal 38) of the recloser 10 can be varied relative to the mounting bracket 200 to facilitate making connections to the second terminal 38.

For example, in the illustrated embodiment, the recloser 10 can be mounted in a first orientation (FIG. 7A) in which the second axis 42 and second terminal 38 are perpendicular to the backing frame 204, a second orientation (FIG. 7B) in which the second axis 42 and second terminal 38 are offset 45 degrees from the first orientation, a third orientation (FIG. 7C) in which the second axis 42 and second terminal 38 are offset 90 degrees from the first orientation, a fourth orientation (FIG. 7D) in which the second axis 42 and second terminal 38 are offset 180 degrees from the first orientation, a fifth orientation (FIG. 7E) in which the second axis 42 and second terminal 38 are offset 270 degrees from the first orientation, and a sixth orientation (FIG. 7F) in which the second axis 42 and second terminal 38 are offset 315 degrees from the first orientation.

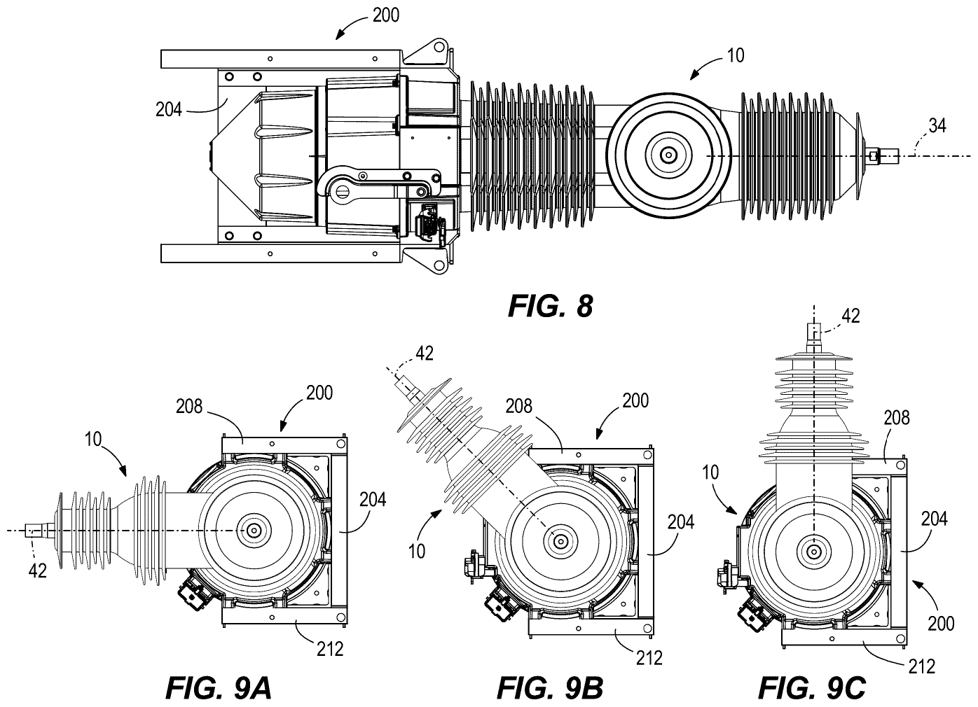

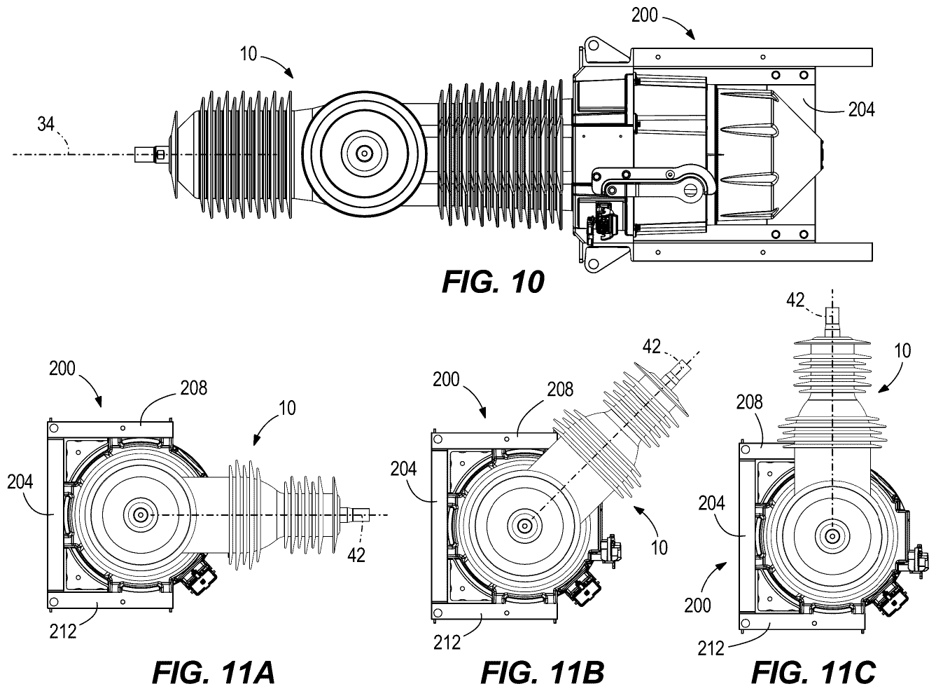

Referring to FIGS. 8-11C, the orientation of the mounting bracket 200 may also be varied to change the orientation of the first terminal 30 of the recloser 10 (e.g., from vertical to horizontal) to facilitate making connections to the first terminal 30. For example, in the illustrated embodiment, the recloser 10 can be mounted in a first plurality of orientations (FIGS. 8-9C) with the first terminal 30 extending in a first direction (i.e. to the right in FIG. 8), and the recloser 10 can be mounted in a second plurality of orientations (FIGS. 10-11C) with the first terminal 30 extending in a second direction (i.e. to the left in FIG. 10) opposite the first direction. In each case, the recloser 10 can be mounted in at least first orientation (FIG. 9A and FIG. 11A) in which the second axis 42 and the second terminal 38 are perpendicular to the backing frame 204, a second orientation (FIG. 9B and FIG. 11B) in which the second axis 42 and second terminal 38 are offset 45 degrees from the first orientation, and a third orientation (FIG. 9C and FIG. 11C) in which the second axis 42 and second terminal 38 are offset 90 degrees from the first orientation.

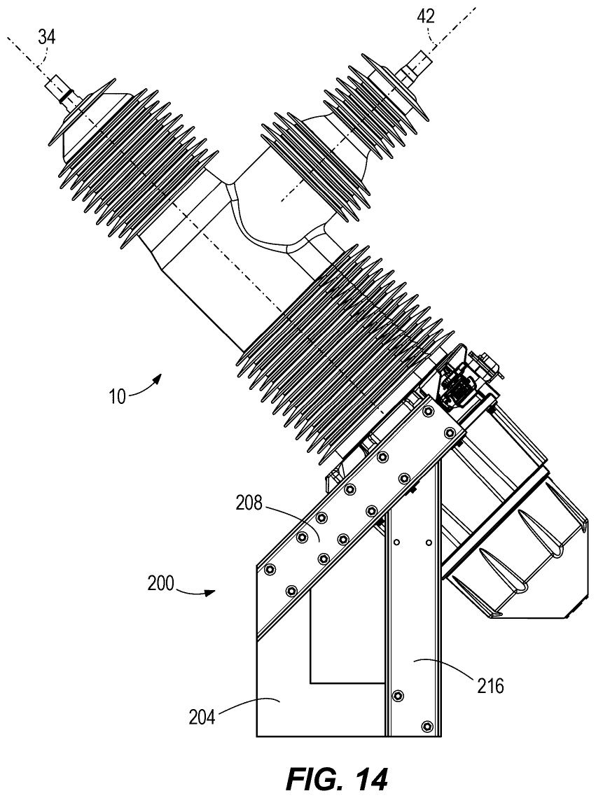

With reference to FIG. 14, in some embodiments, the mounting bracket 200 may be configured to support the recloser 10 such that the first axis 34 is oriented at an angle relative to the backing frame 204 and the horizontal and vertical directions. For example, the embodiment illustrated in FIG. 14, the mounting bracket 200 supports the recloser 10 such that the first axis 34 is angled at 45 degrees relative to vertical. In such embodiments, the backing frame 204 may have an L-shape to facilitate mounting the backing frame 204 to a pole, a concrete pad, or the like.

Thus, the present disclosure provides a high voltage recloser 10 suitable for use in power transmission applications up to 72.5 kV. The recloser 10 includes a mounting head 118 and mounting bracket 200 that allow the recloser 10 to be mounted on a pole or at a substation in a variety of different vertical, horizontal, and angled orientations. That is, the recloser 10 can be assembled to suit a wide variety of different applications, which may provide significant cost savings and manufacturing efficiency.

Various features and advantages of the invention are set forth in the following claims.

What is claimed is:

1. A switchgear apparatus comprising:
a vacuum interrupter assembly having a movable contact and a stationary contact;
a main housing surrounding the vacuum interrupter assembly;
a first terminal electrically coupled to the movable contact, the first terminal extending from the main housing along a first axis;
a second terminal electrically coupled to the stationary contact, the second terminal extending from the main housing along a second axis; and
a mounting head couplable to the main housing in a plurality of orientations about the first axis.

2. The switchgear apparatus of claim 1, further comprising an actuator assembly configured to move the movable contact relative to the stationary contact; and an actuator housing at least partially enclosing the actuator assembly.

3. The switchgear apparatus of claim 2, wherein the actuator housing is coupled to the mounting head opposite the main housing.

4. The switchgear apparatus of claim 2, wherein the actuator assembly includes an electromagnetic actuator and a manual trip assembly.

5. The switchgear apparatus of claim 4, wherein the manual trip assembly includes a handle and a shaft coupled to the handle, wherein the shaft extends through the mounting head.

6. The switchgear apparatus of claim 2, wherein the mounting head is coupled between the main housing and the actuator housing, and wherein the mounting head is configured to be selectively coupled to the main housing in a plurality of different rotational orientations about the first axis relative to the main housing such that the main housing may be selectively positioned in a plurality of different rotational orientations about the first axis relative to the actuator housing.

7. The switchgear apparatus of claim 6, wherein the mounting head includes a plurality of mounting bosses extending from an exterior surface of the mounting head, each mounting boss spaced apart from each adjacent mounting boss about a perimeter of the mounting head.

8. The switchgear apparatus of claim 7, wherein each mounting boss is configured to be coupled to a same support such that the main housing may be selectively positioned in a plurality of different rotational orientations about at least one of the first axis or the second axis relative to the support when the mounting head is coupled to the support.

9. The switchgear apparatus of claim 8, wherein the support is a mounting bracket configured to couple the switchgear apparatus to a pole.

10. The switchgear apparatus of claim 9, wherein the plurality of mounting bosses includes a first pair of mounting bosses, a second pair of mounting bosses, and a third pair of mounting bosses.

11. The switchgear apparatus of claim 10, wherein the first pair of mounting bosses is configured to be coupled to a first arm of the mounting bracket, wherein the second pair of mounting bosses is configured to be coupled to a second arm of the mounting bracket, and wherein the third pair of mounting bosses is configured to be coupled to a backing frame of the mounting bracket.

12. A switchgear apparatus comprising:
a vacuum interrupter assembly having a movable contact and a stationary contact;
a main housing surrounding the vacuum interrupter assembly;
an actuator assembly configured to move the movable contact relative to the stationary contact, and an actuator housing at least partially enclosing the actuator assembly;
a first terminal electrically coupled to the stationary contact, the first terminal extending from the main housing along a first axis;
a second terminal electrically coupled to the movable contact, the second terminal extending from the main housing along a second axis; and
a mounting head coupled between the main housing and the actuator housing, wherein the mounting head is configured to selectively position the main housing in a plurality of different orientations about the first axis relative to the actuator housing.

13. The switchgear apparatus of claim 12, wherein the actuator housing is coupled to the mounting head opposite the main housing.

14. The switchgear apparatus of claim 12, wherein the actuator assembly includes an electromagnetic actuator and a manual trip assembly, the manual trip assembly having a handle accessible from an exterior of the switchgear apparatus and a shaft operatively coupled between the handle and the movable contact, and wherein the mounting head is configured such that the main housing can be selectively positioned in a plurality of different orientations about the first axis relative to the handle.

15. The switchgear apparatus of claim 12, wherein the mounting head includes a first pair of mounting bosses, a second pair of mounting bosses, and a third pair of mounting bosses, and further comprising a mounting bracket having a first arm configured to be coupled to the first pair of mounting bosses, a second arm configured to be coupled to the second pair of mounting bosses, and a backing frame configured to be coupled to the third pair of mounting bosses.

16. The switchgear apparatus of claim 15, wherein the mounting bracket is configured to couple the switchgear apparatus to a pole.

17. The switchgear apparatus of claim 15, wherein the backing frame defines a plane and the mounting bracket is configured to selectively position the switchgear apparatus such that the first axis extends in a direction that is not parallel to the plane when the mounting head is coupled to the mounting bracket.

18. The switchgear apparatus of claim 15, wherein the mounting head and mounting bracket are configured to selectively position each of the first axis and the second axis in a plurality of different orientations relative to the mounting bracket when the mounting head is coupled to the mounting bracket.

19. The switchgear apparatus of claim 15, wherein the mounting head is configured to selectively position the switchgear apparatus such that the first terminal extends in a first direction relative to the backing frame and a second direction different from the first direction relative to the backing frame.

20. The switchgear apparatus of claim 15, wherein the mounting head is configured to selectively position the main housing in a plurality of different orientations about the first axis relative to the mounting bracket when the mounting head is coupled to the mounting bracket.
